(19) United States
(12) Patent Application Publication
(10) Pub. No.: US 2005/0091093 A1
(43) Pub. Date: Apr. 28, 2005

(54) End-to-end business process solution creation

(75) Inventors: Kumar Bhaskaran, Englewood Cliffs, NJ (US); Stephen J. Buckley, White Plains, NJ (US); Nathan S. Caswell, Yorktown Heights, NY (US); Hung-Yang Chang, Scarsdale, NY (US); Joachim H. Frank, Greenwich, CT (US); Rainer F. Hauser, Thalwil (CH); Ying Huang, Yorktown Heights, NY (US); Shubir Kapoor, Mohegan Lake, NY (US); Jana Koehler, Luzern (CH); Santhosh Kumaran, Croton On Hudson, NY (US); Prabir Nandi, Bayside, NY (US); Anil Nigam, Stamford, CT (US); Zhong Tian, Beijing (CN); Jian Wang, Beijing (CN); Frederick Y. Wu, Cos Cob, CT (US); Jun Zhu, Beijing (CN)

Correspondence Address: STEVEN FISCHMAN, ESQ.;SCULLY, SCOTT, MURPHY AND PRESSER, 400 Garden City Plaza, Garden City, NY, 11530, US

(73) Assignee: INERNATIONAL BUSINESS MACHINES CORPORATION, ARMONK, NY (US)

(21) Appl. No.: 10/692,898

(22) Filed: Oct. 24, 2003

(51) Int. Cl. G06F 17/60

(52) U.S. Cl. 705/7

(57) ABSTRACT

A system and method for creating and managing a business process integration solution comprises modeling a business strategy including elements representing business measurements and initiatives according to defined business goals and objectives of an entity; modeling business operations of the entity in terms of business process elements including process tasks, artifact flows and artifact repositories, and business commitment elements including incorporating key performance indicators; mapping elements of the strategy model with artifact and process elements of the operations model; and, measuring business performance and comparing performance measurements against the key performance indicators. The business strategy and operation model process elements may be continuously refined over a solution development lifecycle as a result of process measurements and comparing. A business level modeling language is further implemented for formally representing the business operations.

### CROSS REFERENCE TO RELATED APPLICATIONS

This application relates to and wholly incorporates the subject matter of commonly owned co-pending U.S. patent application No. ______ (U.S. Attorney Docket No. YOR920030143US1 (16596)), filed Jun. 5, 2003, the whole contents and disclosure of which is incorporated by reference as if fully set forth herein.

### BACKGROUND OF THE INVENTION

1. Field of the Invention

The present invention relates to business systems and infrastructures generally, and more particularly, to a system and method for creating and managing business process integration solutions.

2. Description of the Prior Art

Starting from a business process from user knowledge and existing documentation and creating an optimized IT solution that operates and manages the process is presently a very expensive, time-consuming undertaking. Currently, business process modeling has limited usefulness, i.e., it is largely documented in text documents including freehand diagrams etc. and lacks formal semantics. Results thus comprise unstructured solution knowledge sharable only at the code level. Furthermore, completed solution cannot be easily or automatically reconciled with the original process model and business process performance is difficult to measure and use to reengineer the process.

Known solutions to this problem currently are not cost-efficient nor time-efficient and, moreover, do not span the entire end-to-end business process. For example, Holosofx is a popular tool for creating business process models and workflows, but cannot be used to generate other necessary components, such as application adapters or business objects. Crossworlds InterChange Server is a tool for implementing business objects and business logic operations, but does not perform business process modeling or workflow generation and processing.

It would thus be highly desirable to provide a system and method for business process integration and management solutions.

Furthermore, it would be highly desirable to provide a business level modeling language that formally describes functional business models from a variety of perspectives including a strategic operational and execution point of view that serves as a basis for implementation as an Information Technology (IT) execution model, and further, facilitates business process re-engineering according to changing business goals and objectives over its development lifetime.

### SUMMARY OF THE INVENTION

It is an object of the present invention to provide a cost-saving and time-saving solution for providing a business process integration and management solutions, particularly novel procedures from which an IT solution for a business process may be created.

According to the preferred embodiment of the invention, there is provided a complete system and methodology for creating business integration and management solutions. A point of novelty of the invention is its formal definition of the modeled business activities and output of each step in the solution creation process. In each step, one or more documents or other artifacts are created in accordance with well-defined schemas and specifications. Key steps are automated by algorithms in software, or assisted by tooling with graphical user interfaces. The schemas and specifications enforced the validity of the work products and guarantee compatibility with other components and the overall model. Another critical element is the incorporation of key performance indicators in the very early stages, followed through with implementation of software probes to collect the business process performance data. Once the solution is deployed, these data are reported to the business analyst for performance tuning and business process re-engineering.

In the achievement of these objects, a comprehensive methodology and tool set is provided for the complete lifecycle of a business process solution spanning: 1) business strategy modeling at the strategy level; 2) business process modeling at the operational level and, defining in the operational model, the business process measurements in terms of commitments and key performance indicators; 3) and transforming of the process model to an information technology (IT) solution composed of solution artifacts of pre-defined types including: Business Objects, Adaptive Business Objects, Macroflows, Microflows, EAI Adapters, B2B Connectors, User Interaction Screenflows; 4) simulation of the models to perform static and dynamic analysis; 5) mapping of the key performance indicators to rr probes in the rr solution; 6) defining details of the IT solution artifacts in an integrated set of graphical tools; 7) binding and deploying the solution artifacts to platform-specific runtimes; 8) Monitoring and reporting business process performance as measured by the key performance indicators being serviced by event data from probes; and 9) optional invocation of agents to recommend and/or effect changes to the business process that improve its performance.

### BRIEF DESCRIPTION OF THE DRAWINGS

The objects, features and advantages of the present invention will become apparent to one skilled in the art, in view of the following detailed description taken in combination with the attached drawings, in which:

FIG. 1 depicts a generic block diagram illustrating the model-driven approach for bringing about Adaptive Business Solutions according to the present invention;

FIG. 2 illustrates the end-to-end Business Process Modeling system and components 100 according to the present invention;

FIG. 3 illustrates conceptually the business solution creation life-cycle according to the present invention; and,

FIG. 4 illustrates conceptually the Business Operational Specification (BopS) model for representing an operational view of a business.

### DETAILED DESCRIPTION OF THE PREFERRED EMBODIMENTS

This invention defines a procedure by which an IT solution for a business process can be created. In each step a specific set of artifacts are created for possible use in future steps, or for later re-use during creation of additional solutions.

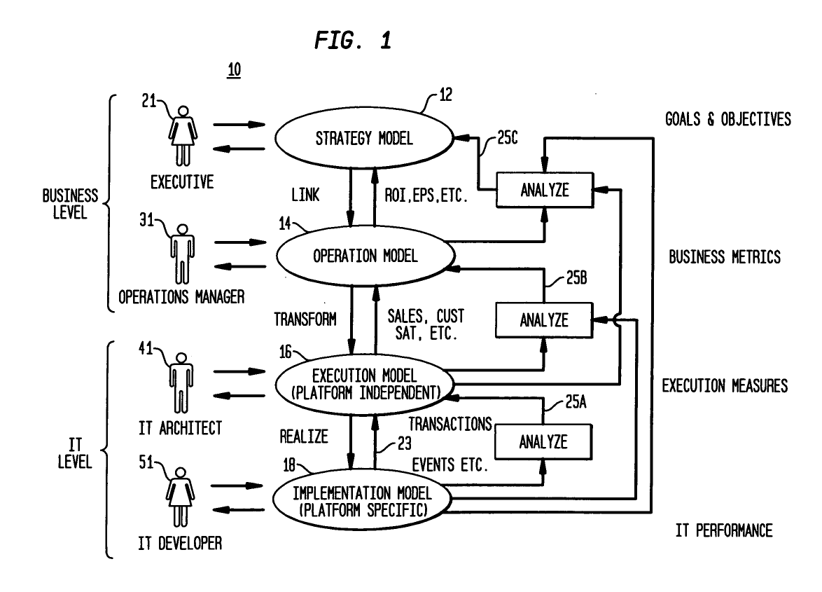

FIG. 1 depicts the model-driven approach 10 for bringing about Adaptive Business Solutions. In this approach, the business semantics are captured and then IT changes are directly implemented that change the business. The approach includes: (1) a step of modeling businesses at the appropriate levels of abstraction for each main user role and purpose, and (2) mapping, transforming, and connecting these models to one another and to the IT infrastructure such that manipulating models corresponds to manipulating implementation code. The benefit of manipulating models rather than code is that generally, models are easier to understand and manipulate than code. For example, a business user—whether this is a line of business manager, business analyst or a business process designer specialist—who needs to modify a business operation does not want to manipulate Java code or even BPEL (Business Process Execution Language) scripts to understand the current process or make changes to it, just like an object-oriented Java developer does not want to manipulate assembly code. Rather, the line of business manager wants to manipulate a visual business operation model, which is the appropriate level of abstraction of this business semantic for this user and purpose.

As shown in FIG. 1, the approach 10 includes a step of making the models become executable like code. Three levels of models for three main user roles and organization purposes includes: 1) a strategy model 12 that defines the business goals and objectives, e.g., in the form of scorecards (quantification of goals) and targets (measurable objectives). Such strategy modeling is performed, for instance, by an executive 21, or like business professional; 2) the operation model 14 defines what the business does in terms of business processes, commitments, and KPI (Key Performance Indicator) metrics which get mapped to the scorecard for comparison with their strategic targets. Such operation modeling is performed, for instance, by an Line-of-Business (LOB) manager 31, business analyst, or like business level user. In the generation of the strategy model, data link structures are provided to map the strategy model with the operations model. Preferably, the operation model 14 is semi-automatically transformed into 3) an execution model 16 that defines how the business operation is executed in terms of specific applications, data sources, people and partners—but in a platform-independent way. Such execution modeling is performed, for instance, by an IT architect 41, or like IT professional. In the generation of the strategy model, software data structures are provided to transform the operations model into the execution model. Finally, some development may be required to connect the platform-independent execution artifacts to 4) a specific platform implementation model 18 such as the WAS J2EE or MS NET platform, and implement specific APIs such as by using Web Services, for example. Such implementation modeling is performed, for instance, by an IT developer 51, or like IT professional.

With these mappings, transformations, and connections in place, raw events, transactions 23, and environmental data can be captured and aggregated into business metrics, e.g., return on investment (ROI) or Earnings per share (EPS), for comparison with business commitments and objectives in a Business Activity Monitoring (BAM) dashboard, for example. Through a number of feedback loops 25a-25c, Continual Optimization/Sense and Respond (CO/SaR) technologies may then provide decision support to manage operational exceptions and proactively suggest process changes to optimally achieve business objectives. Finally, changes in business direction can now be directly propagated from the strategy model down to the IT infrastructure mostly by manipulating models rather than code—requiring far less time and cost than traditional business transformation engagements. This allows the business to adapt as quickly and easily as adapting the models.

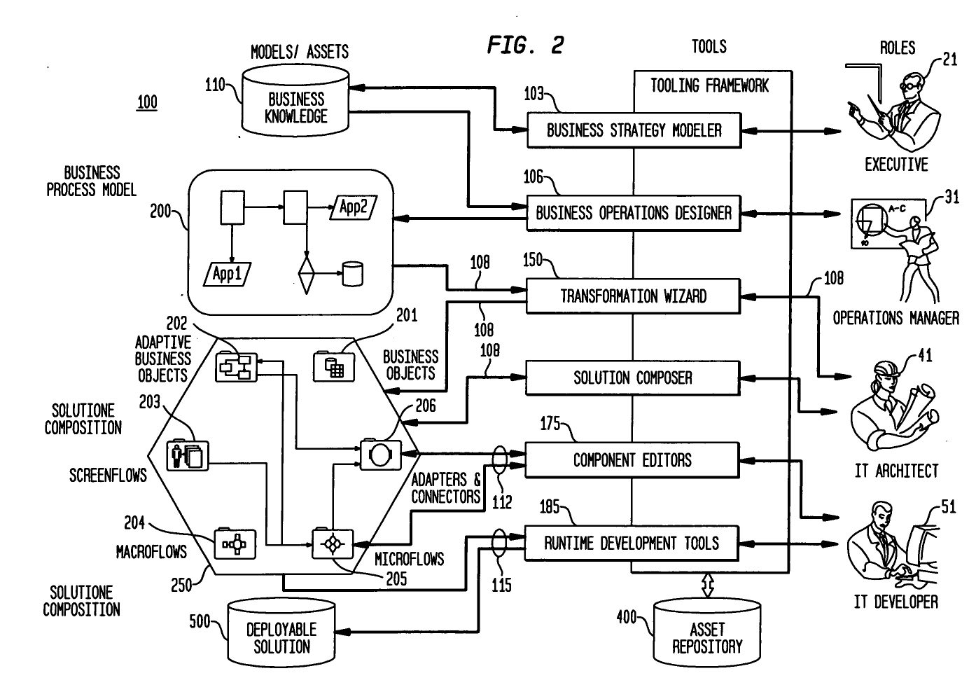

FIG. 2 illustrates the end-to-end Business Process Modeling system 100 and components. In a preferred embodiment, the first step 103 of the ABS concept is to populate a Business Level Modeling (BLM) repository, e.g., a memory storage device or database 110, using externally defined business content. The above-described business professional, e.g., executive, may implement a business strategy modeler tool or any like method of gathering or generating externally defined business content for storage in the repository 110. This content includes, but is not limited to, documentation of the business process that may already exist or may need to be created through interviews with people involved in the process. Next, at step 106, involves utilizing a business analyst (e.g. business operations manager) to create a formal model of the business operation, e.g., by using a tool called the Business View Editor (BVE). The BVE is a graphical tool that allows a business user or analyst to create a model of the business process as a diagram 200, of which each component and connection has a well-defined meaning. The graphical representation 200 of the process has a corresponding textual representation in a document conforming to a schema, such as an XML schema, for example. As will be explained in greater detail herein, such schema provide a formal process sub-model of the business operations including modeling process tasks, business artifact flows and artifact repositories. The business process model 200 may be stored in the same Business Level Model (BLM) repository 110, for later retrieval, re-use, customization, or modification, or in another like repository (not shown). As will be explained in greater detail herein, the business process model is described in a formal language referred to as BOpS (Business Operational Specification) that specifies the operational view of a business. Another step 108 implementing a tool, called a Transformation Wizard 150 is used to transform a BLM 200 into an IT Level Model (ILM) 250. Such a transformation process is described in further detail in commonly owned, co-pending U.S. patent application No. ______ (U.S. Attorney Docket No. YOR920030143US1 (16596)) incorporated by reference herein.

More specifically, the Transformation wizard 150 may automatically transform the business level model to an IT level model (ILM) 250. The Transformation Wizard may be automated by one or more alternative algorithms that use different approaches to generating an IT architecture for the solution. The algorithms identify the necessary components that will be used in the ILM 250 including, but not limited to components, such as: business objects 201, adaptive entities (adaptive business objects) 202, screenflows 203, macroflows and workflows 204, microflows (automatically executable tasks) 205, and application or business-to-business adapters 206. An adaptive entity is a prescription for the various states that a business object can have an d transitions that a business object can undergo. A workflow is a sequence of activities, some of which involve human interaction. An application adapter is software that allows an independent application to be integrated with the process. A business-to-business adapter is software that enables an external business partner to be integrated with the process.

Further steps 115 are performed by the IT developers 51 who implement runtime development tools 185 such as IT Level Editor or “Binding Wizard” tool (not shown) that may be used for viewing or modifying the artifacts at this level. Typically, one or more IT Level Artifact Editors are employed to further specify the details of each component. This is necessary because it is not realistic for the business level model to contain sufficient detail to fully define all components at the IT level. Separately, adapters for the existing applications and business partners are either retrieved (if they had been created previously) or created. They are retrieved from the Asset Repository 400, and used by a “Binding Wizard” tool, along with the artifacts in the ILM to generate the bindings between components, which are then stored in the asset repository 400. The binding wizard particularly uses the adapter defined and the commands in the ILM repository to create concrete bindings.

A further runtime development tool is a Package Generator creates a deployable solution, e.g., files, and deploys them on local or remote machines. That is, based on the selected software and hardware platforms and topology, platform-specific components are created and the entire solution is packaged and stored in a runtime artifacts repository 500. This package is then ready for testing and deployment in a customer's environment.

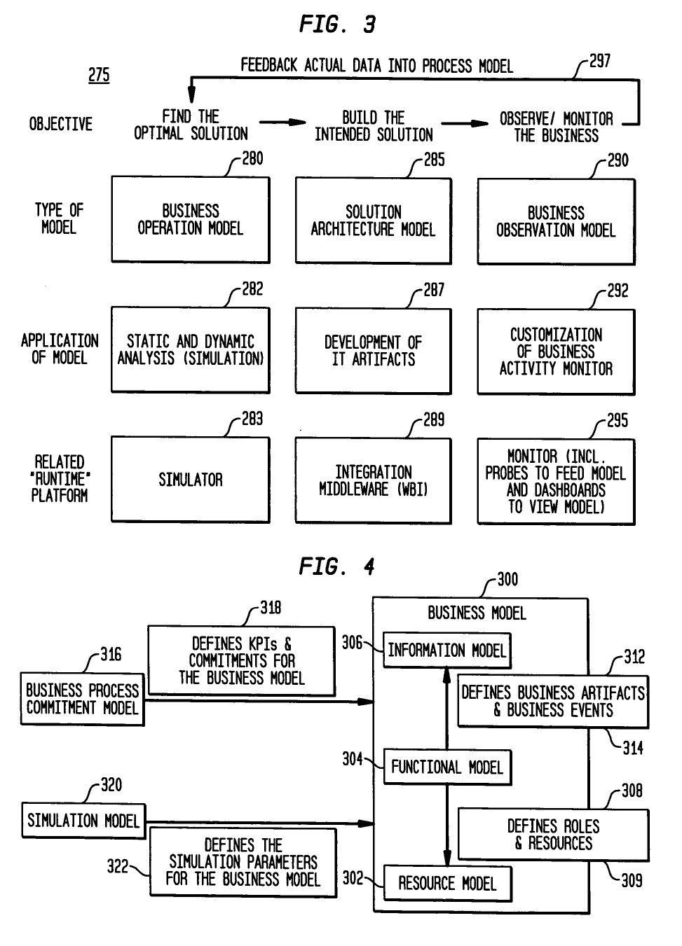

FIG. 3 depicts conceptually, how the business solution is created and managed over the development life-cycle 275. As shown, the business objective of finding an intended solution includes a hierarchy of formally representing the business operation model 280, e.g., using a business process modeling language such as BOpS as will be explained in greater detail herein; performing static and dynamic analysis 282 on a related “runtime” platform such as a simulation engine 283. As described herein, to build the intended solution requires developing an architectural model 285, developing IT artifacts 287 and then generating integration middleware (WBI) 289. From this, the business is observed and monitored by performing steps of generation of the business observation model 290, customizing the business activity monitors 292 and implementing probes (to feed model) and dashboards to view model 295. The observations and monitor data are feedback 297 to the first hierarchy in order to further refine and find the optimal solution.

As described hereinabove the Business Process Model is described according to a Business Operational Specification (BOpS) which is a business level modeling language. Business level models provide a formal representation of a business's operations, reflecting procedures and business policies, customer requirements, constraints, and a solution context. Business Analysts and Line of Business users will define such models.

Business level models can be used stand-alone, independent of any IT implementation: for cost analysis, process simulation, resource allocation or optimization studies. One of the intended purposes of a BOpS model is to serve as the basis for this class of stand-alone applications. In addition, a BOpS model is intended to be used as a starting point, and top-level “bracket” for IT implementations: as a starting point, because additional tools and procedures will be provided that will help refine the model to the level of executable solutions; and, as a top-level bracket, because the BOpS model will remain interlocked with the deployed solution, and serve as the basis for business activity monitoring, process analysis based on real-time data, and process re-engineering.

Other extensions of a BOpS model may cover enterprise models for: resource allocation and deployment, accounting and charging, asset management, security, directories and organizational structure, enterprise information models, internal and external communication channels, etc. It is expected that a BOpS model serve as a common core and starting point for virtually every aspect of modeling an enterprise.

A BOpS model is a formal representation of the business owner's view. A second way of positioning BOpS is with respect to the solution development life cycle: It is the first formal representation of a solution, succeeding the initial opportunity assessment and requirements gathering, strategy formulation and preceding any IT architecture definition.

Yet another way of positioning BOpS is with respect to the granularity of modeling a solution: It is the most fine-grained representation that business-level users win recognize. From a business user's point of view, BOpS tasks, resources, and artifacts are “atomic”. (One may tear an invoice in pieces, or disassemble a computer, but the results will no longer be recognized as “business documents” or “system resources”).

There are three views of a business system. The operational view that projects what the business does, the strategy view that describes why it does that, and the execution view that depicts how it does that. Most of the work on business process modeling focuses on the execution layer. BOpS is built on the idea that the best way to present the operational view of a business is to focus on the artifacts that the business operates on and the business elements that impact the lifecycle of those artifacts. These business elements fall into three categories: business tasks that represent irreducible business functions performed in the context of those artifacts, artifact repositories that serve as the storage for these artifacts, and the business processes that define a topology on an aggregation of business elements. The business model described by BOpS is further decomposed into three sub models. The information model captures the business artifacts and business events. The functional model captures business processes, business tasks, and the artifact repositories. The resource model captures the roles and resource groups.

It is very natural to find that modeling business operations involves modeling these three fundamental constituents of a statement: Subjects (actors), verbs (actions), and objects (artifacts). Correspondingly, as shown in FIG. 4, a BOpS model 300 has three parts: a Resource Model (describing the actors) 302; a Functional Model (describing the actions) 304; and, an Information Model (describing the artifacts) 306. The Resource Model 302 describes the actors and their capabilities. Resources 308, which may be human, automated, or external, qualify for roles, which are defined as aggregations of capabilities to perform tasks. Roles 309 may be “scoped”, in which case these capabilities have task instance (or artifact) dependencies. It is noted that resources may be owned by organizations (business units, departments, partners . . . ). The Functional Model 304 describes the actions in the form of business processes, business tasks and artifact repositories that serve as the storage of the artifacts that the business operates on. It is also where the coherence of the model is established: Which tasks operate upon which artifacts using what kind of resources, and how tasks are interconnected (sequenced) through the exchange of artifacts. Finally, the Information Model 306 describes the artifacts (“documents”, “work products”) 312 and business events (“messages”, “signals”) 314 that business tasks exchange. In addition, it features task contexts, which hold temporary information needed by a task, and business predicates, which model constraints for, and relationships between, all information model constituents.

As further shown in FIG. 4, there is illustrated the use of two complementary models that work in conjunction with BOpS. The Business Process Commitment Language (BPCL) 316 is used to specify the Key Performance Indicators (KPIs) 318 of the business operation. The Simulation Model 320 including schema 322 to specify the simulation parameters of the business operation.

An overview of the syntax of BopS is now described with details of each language construct described in greater detail herein. At the highest level, BOpS uses the Business Model construct to define the operational view of a business. Included in the business model are the Information Model, Functional Model, and the Resource Model. This specification uses an informal syntax to describe the XML grammar of the XML fragments below: The syntax appears as an XML instance, but the values indicate the data types instead of values; Grammar in bold has not been introduced earlier, or is of particular interest in an example; the <--description--> is a placeholder for elements from some “other” namespace (like ##other in XSD); characters are appended to elements, attributes, and <!--descriptions--> as follows: “?” (0 or 1), “*” (0 or more), “+” (1 or more). The characters “[” and “]” are used to indicate that contained items are to be treated as a group with respect to the “?”, “*”, or “+” characters; elements and attributes separated by “|” and grouped by “(” and “)” are meant to be syntactic alternatives; the XML namespace prefixes (defined below) are used to indicate the namespace of the element being defined; examples starting with <?xm1 contain enough information to conform to this specification; others examples are fragments and require additional information to be specified in order to conform; XSD schema is provided as a formal definition of grammar. The syntactic structure of the root businessModel is now described with the basic structure of the language as follows:

```
<businessModel name=”string” targetNamespace=”anyURI”?
  expressionLanguage=”anyURI”?
  xmlns=“http://www.ibm.com/2002/07/business-process/bops/”>
  <informationModel>
    informationmodel
  </informationModel>
  <functionalModel>
    <businessProcess name=”ncname” abstract=”true|false”? external=” true|false”?
        automatic=” true|false”? transactional=” true|false”? compensation=” true|false”?>+
      businesselement (businessProcess, businessTask, artifactRepository)*
    </businessProcess>
    <businessTask name=”ncname” automatic=” true|false”? transactional=” true|false”?
        compensation=” true|false”?>*
      businesselement (businessTask)
    </businessTask>
    <artifactRepository name=”ncname” >*
      businesselement (artifactRepository)
    </artifactRepository>
  </ functionalModel >
  <resourceModel targetNamespace=”anyURI”>?
    <roles>?
      <role name=”string”>+
        <scopes>?
          <scope name=”string”? value=”string”>+
        </scopes>
      </role>
    </roles>
    <resources>
      resourceGroup
    </resources>
  </resourceModel>
  <constraints/>?
    tConstraints?
  </constraints>
</bops>
```

According to the basic structure shown, the top-level attributes are as follows: “name” which attribute defines the name of the model; “targetNamespace” which attribute defines the targetNamespace of the document; “expressionlanguage” which attribute specifies the expression language used in the process. A current default for this attribute is XPath 1.0, represented by the URI of the XPath 1.0 specification, e.g., at http://www.w3.org/TR/1999/REC-xpath-19991116; the “informationModel”describes the above-mentioned artifacts and business events pertaining to the operational view of the business; the “functionModel” describes the above-mentioned process, task, artifact repositories and their interconnections using ports and links; the “resource Model” describes the above-mentioned organizational roles and the resource groups relevant to the business operations; and the “constraints” describes the constraints that ensure semantic validity of a BOpS business model.

Functional Model

As mentioned, the token “businesselement” can be any of the following: businessProcess; businessTask; and artifactRepository. The <businessProcess> construct describes the business process with the basic structure of the language as follows:

```
< businessProcess name=”ncname” abstract=” true|false”?
external=” true|false”?
    automatic=” true|false”? transactional=” true|false”?
    compensation=” true|false”?>
  ports?
  <links>?
    <link fromport=”ncname” toport=”ncname” />*
  </links>
  businesselement (businessProcess, businessTask, artifactRepository)*
  roles?
</ businessProcess>
```

The <businessTask> construct describes the business task as follows:

```
< businessTask name=”ncname” automatic=”true|false”?
    transactional=” true|false”? compensation=” true|false”?>
  ports?
  <taskContext>?
      <contextVariable name=”ncname”
      type=”qname”? value=”string”?>*
        <predicate name=”ncname” expression=”string”/>?
      </contextVariable>
  </taskContext>
  roles?
  <trigger timer=”true|false”? self=”true|false”?>?
    <port id=”ncname”/>*
  </trigger>
</ businessTask >
```

The <artifactRepository> construct describes the artifact repository as follows:

<artifactRepository name=”ncname” label=”string”?>
ports?
</artifactRepository >

The token “ports” referred to above is described s follows:

```
<ports>
  <port name=”string” direction=” in|out|in-out|out-in”
  predicate=”string”? identityPassed=” true|false”?
proxyOf=”ncname”?>*
    choice
      <businessArtifactType name=”ncname”/>
      <businessEventType name=”ncname”/>
    choice
    <predicate name=”ncname” expression=”string”/>?
  </port>
</ports>
```

Information Model

The token “informationmodel” referred to above is described as follows:

<businessArtifactType name=”ncname” type=”qname”?/>*
<businessEventType name=”ncname” type=”qname”?/>*
<predicate name=”ncname” expression=”string” />*

Resource Model

The token “roles” referred to above is described as follows:

```
<roles>
    <role roleref=”qname”?>*
        <brm:role>?
        ...
        <brm:role>
    </role>
</roles>
```

The token “resourceGroup” referred to above is described as follows:

```
<resource name=”string” aggregationType=”bag|sequence|alternative?”>*
  tAtomicResource
  resourceGroup
</resource>
<humanResource name=”string” aggregationType=”bag|sequence|alternative?”>*
  tAtomicResource
  <humanResource name=”string” aggregationType=”bag|sequence|alternative?”/>*
</ humanResource>
<systemResource name=”string” aggregationType=”bag|sequence|alternative?”>*
  tAtomicResource
  < systemResource name=”string” aggregationType=”bag|sequence|alternative?”/>*
</ systemResource >
<externalResource name=”string” aggregationType=”bag|sequence|alternative?”>*
  tAtomicResource
  < externalResource name=”string” aggregationType=”bag|sequence|alternative?”/>*
</ externalResource >
```

The token “tAtomicResource” referred to above is described as follows:

```
<attributes>?
  <attribute name=”string” value=”string”?>+
    <description/>*
  </attribute>
</attributes>
<roles>
  <role name=”string”>+
    <scope name=”string”? value=”string”>*
  </role>
</roles>
```

Constraints

The constraints are described using Boolean Xpath expressions and must evaluate to true for the model to be semantically valid. The token “tConstraints” referred to above is described as follows:

```
<constraints>?
  <constraint name=”ncname” expression=”string”>*
    <description/>?
  </constraint>
</constraints>
```

BOpS business models capture the lifecycle of the key artifacts of the business operation and the business events that impact the lifecycle. Business logic at the operational level is captured using business predicates. Business artifacts, business events, and the business predicates are the underpinnings of the BOpS information model.

```
<xs:complexType name=“tArtifact”>
    <xs:attribute name=“name” type=“xs:NCName” use=“required”/>
    <xs:attribute name=“type” type=“xs:QName” use=“required”/>
</xs:complexType>
```

BOpS business models capture the lifecycle of the key artifacts of the business operation and the business events that impact the lifecycle. Business logic at the operational level is captured using business predicates. Business artifacts, business events, and the business predicates are the underpinnings of the BOpS information model.

Business Artifacts

The use of BOpS in defining the operational view of this example business and a description of the businesss' core constructs is also provided. In an example travel agent business, a travel reservation process identifies the required flight legs and hotel reservations for a customer' planned trip. It then spawns sub-processes responsible for reserving the flights and hotels. If all reservations are confirmed within a pre-defined time limit, an itinerary is printed and sent to the customer.

As mentioned, the BOpS captures the lifecycle of a business artifact as a flow of an artifact type through the business elements. The cardinality attribute of the artifact type indicates any limits on the instances of a certain artifact type. The artifact type also identifies the information variables for that artifact type. An artifact is either worked on by a Business Task or resides in an Artifact Repository. An artifact has the following attributes: name: ncname—specifies the name of the artifact; and, type: qname—specifies the type of the artifact. It is a qualified name so it could be in another namespace. An artifact is described by its type attribute that is a qualified name (referring to a namespace). The syntactic structure of an example artifact is as follows:

```
<xs:complexType name=“tArtifact”>
    <xs:attribute name=“name” type=“xs:NCName” use=“required”/>
    <xs:attribute name=“type” type=“xs:QName” use=“required”/>
</xs:complexType>
```

Business Events

Business events (for example, a fax or a phone call from a customer) may carry artifact references or copies of artifact content. Thus, a business event has the following attributes: name e.g., “ncname” specifying the name of the artifact; and, type, e.g., “qname” specifying the type of the artifact. It is a qualified name so it could be in another namespace. A business event is described by its type attribute that is a qualified name (referring to a namespace). The syntactic structure of a business event is as follows:

```
<xs:complexType name=“tBusinessEvent”>
    <xs:complexContent>
        <xs:extension base=“tArtifact”/>
    </xs:complexContent>
</xs:complexType>
```

Business Predicates

A business predicate is an expression of conditional logic in terms of the information variables and/or artifact attributes in the model. A business predicate can be used in the following sections in the BOpS model: a Port—as a boolean expression whose evaluation decides if the artifact flows through the port; a ContextVariable—as a regular expression whose evaluation sets the value on the variable; and Constraint(s)—as a boolean expression whose evaluation validates the model. A predicate is expressed using XPath. It has the following attributes: name: ncname—a unique name for the predicate; and, expression: string: an XPath expression expressed in terms of an artifact, business event or context variable. The syntactic structure of a predicate is as follows:

```
<xs:complexType name=“tPredicate”>
    <xs:attribute name=“name” type=“xs:NCName” use=“required”/>
    <xs:attribute name=“expression” type=“xs:string” use=“required”/>
</xs:complexType>
```

As mentioned, the Business Function Model includes BusinessElements and their connections. A Business Element is a general construct in the functional model, i.e., it is manifested as a Business Process, Business Task or as an Artifact Repository. The Business Function Model is built on the core concept of business artifacts (e.g. purchase orders, customer records, contracts, invoices). It is noted that the structure of business artifacts and business events is described using the constructs of the Information Model, while their life cycle is described by the Operations Model; and business events (e.g. timer signals, alerts, notifications) being exchanged amongst business tasks. Business tasks have ports through which artifacts and events enter or exit. The ports are connected via links. Furthermore, the model features artifact repositories, which is where business artifacts reside when they are not processed in a task, and business processes which aggregate tasks, artifact repositories, and potentially nested processes, into larger operational units. It is noted that a fundamental difference between the Business Function Model and many of the existing “flow models” is that in BOpS, there are no flows. There are only tasks, which are spawned by an arriving artifact or event, perform some work, and finally send out events and artifacts which may spawn other tasks in turn. This creates a “web of interacting tasks” connected through the exchange of artifacts and events. One could follow the path of a particular artifact and define the sequence of tasks thus encountered as a “process” or “flow”. However, with this approach a given BOpS model may be dissected into flows in many ways, and for tasks operating on multiple artifacts, it may not even be clear to which flow or process they belong. While a “business process” construct in BOpS is available, this should really be thought of as a “composite task”, since from the outside, it looks and behaves exactly like a task, with ports to send or receive artifacts and events. The only difference is that for processes, their internal, operational structures are further decomposed within BOpS, while elementary tasks are not. The roles are defined in the Resource Model and referred to from the BusinessModel. A role identifies who can perform a business function.

Business Element

A business element is an abstract construct. BusinessProcess, BusinessTask and ArtifactRepository all extend BusinessElement. The syntactic structure of a business element is as follows:

```
<xs:complexType name=“tBusinessElement”>
    <xs:complexContent>
        <xs:extension base=“bops:tExtensibleElements”>
            <xs:sequence>
                <xs:element name=“ports” type=“bops:tPorts” minOccurs=“0”/>
                <xs:element name=“description” type=“xs:string” minOccurs=“0”/>
            </xs:sequence>
            <xs:attribute name=“name” type=“xs:NCName” use=“required”/>
        </xs:extension>
    </xs:complexContent>
    </xs:complexType>
```

Ports define the interface of a business element. A port has the following attributes:
a name: ncname—name of the port;
a direction (in|out|in-out|out-in)—The direction of information flow in the port. Particularly, “in” indicates that a businessArtifact or businessEvent is received on this port. If the port is defined as a trigger port, it will trigger (see task trigger) the start of the task. It must be connected to a corresponding ‘out’ port via a link; “out” indicates that a businessArtifact or businessEvent is sent out via the port. An output port cannot be specified as a trigger (see task trigger) for the task. It must be connected to a corresponding ‘in’ port via a link; “in-out” indicates that a request is received for a businessArtifact and a corresponding response is sent back. An in-out port cannot be specified as a trigger (see task trigger) for the task. These ports are valid for all businessElements and normally specified within artifactRepositories. It must be connected to a corresponding ‘out-in’ port via a link; and, “out-in” indicates that a request is sent out for a businessAtifact and a corresponding response is received. If the port is defined as a trigger port' it will trigger (see task trigger) the start of the task. The understanding here being that the task was listening/polling for certain artifact(s) based on a predefined condition. These ports are valid for tasks and processes (not artifactRepositories). It must be connected to a corresponding ‘in-out’ port via a link;
a predicate: string—a boolean XPath expression whose evaluation determines if the port is active. Information can flow only through an active port;
an identityPassed: is a boolean(true|false) value indicating if the identity of the artifact is passed as part of the information flow. At any instance, only one (1) businessElement can hold the identity of an artifact. A businessElement releases artifactIdentity via ‘out’ or ‘in-out’ ports whose ‘identityPassed’ attribute is set to ‘true’. A businessElement receives artifactIdentity via ‘in’ or ‘out-in’ ports whose ‘identityPassed’ attribute is set to ‘true’. The default is set to true; and,
a proxyOf: ncname indicates referral to a physical port. This attribute indicates that this port is a proxy port and actually refers to another port. It is only applicable for non-abstract processes (which must have ports referring to ports belonging to its child processes, tasks and repositories).

The syntactic structure 6f a port is as follows:

```
<xs:complexType name=“tPorts”>
    <xs:sequence maxOccurs=“unbounded”>
        <xs:element name=“port” type=“bops:tPort”/>
    </xs:sequence>
</xs:complexType>
<xs:complexType name=“tPort”>
    <xs:sequence>
        <xs:choice>
            <xs:element name=“businessEventType” type=“bops:tBusinessEventRef”/>
            <xs:element name=“businessArtifactType” type=“bops:tBusinessArtifactRef”/>
        </xs:choice>
        <xs:element name=“predicate” type=“bops:tPredicate” minOccurs=“0”/>
    </xs:sequence>
    <xs:attribute name=“name” type=“xs:NCName” use=“required”/>
    <xs:attribute name=“direction” type=“tPortDirection” use=“required”/>
    <xs:attribute name=“predicate” type=“xs:NCName” use=“optional”/>
    <xs:attribute name=“identityPassed” type=“xs:boolean” use=“optional” default=“true”/>
    <xs:attribute name=“proxyOf” type=“xs:NCName” use=“optional”/>
</xs:complexType>
<xs:simpleType name=“tPortDirection”>
    <xs:restriction base=“xs:string”>
        <xs:enumeration value=“in”/>
        <xs:enumeration value=“out”/>
        <xs:enumeration value=“in-out”/>
        <xs:enumeration value=“out-in”/>
    </xs:restriction>
</xs:simpleType>
```

Business Process

A Business Process is an aggregation of business elements, i.e., business tasks, artifact repositories, and other business processes to support hierarchical structures. A process has the following attributes—
name: ncname—specifies the name of the business process
abstract: boolean (true|false)—A process with its abstract attribute set to ‘true’ is not hierarchically broken down into further tasks and artifact repositories and is treated as an opaque element. It contains only ports to define its interfaces and roles to denote who can perform its function. If the abstract attribute is not specified, the value defaults to ‘false’.
external: boolean (true|false)—A business process with the external attribute set to ‘true’ indicates that it is external to the enterprise domain of the business that BOpS is modeling. The current version of BOpS models the operations of a business and the interactions of that business with its partners in the context of those operations. If the external attribute is not specified, it is assumed to be ‘false’. An external process would necessarily be abstract (e.g. a manaufacturer would not define the business process of its suppliers) unless otherwise specified.
automatic: boolean (true|false)—A business process with the automatic attribute set to ‘false’ indicates that the process requires human intervention to complete. All tasks within this process inherit the automatic attribute and can override it if necessary. If the automatic attribute is not specified, it is assumed to be ‘true’.
transactional: boolean (true|false)—A business process with its transaction attribute set to ‘true’ indicates that the entire process is treated as a long running transaction, i.e. if an exception occurs during the execution of a process, the entire business state should be reset to the state prior to the commencement of the process execution. If the transactional attribute is not specified, it is assumed to be ‘false’. All tasks inherit the transactional attribute of its parent process.
compensation: boolean (true|false)—A business process with its compensation attribute set to ‘true’ indicates that it supports compensation in the event that it needs to be “rolled back”. If the compensation attribute is not specified, it is assumed to be ‘false’. All tasks inherit the compensation attribute of its parent process.

The business model must contain at least one business process. The business process consists of business elements (process, task, artifactrepository), ports, links, and roles. Ports specify the interface of the business process. Roles specify who have the authority to perform the business function represented by the business process. Links connect ports of the business elements contained in the business process to specify the flow of artifacts through the business elements. A link has the following attributes:
fromport: ncname—a reference to a port id. The direction of the port must be ‘out’ or ‘out-in’.
toport: ncname—a reference to a port id. The direction of the port must be ‘in’ or ‘in-out’.

The syntactic structure of a link is—

```
<xs:complexType name=“tLinks”>
    <xs:sequence>
        <xs:element name=“link” type=“bops:tLink”
        maxOccurs=“unbounded”/>
    </xs:sequence>
</xs:complexType>
<xs:complexType name=“tLink”>
    <xs:attribute name=“fromport” type=“xs:NCName” use=“required”/>
    <xs:attribute name=“toport” type=“xs:NCName” use=“required”/>
</xs:complexType>
```

The syntactic structure of a business process is:

```
<xs:complexType name=“tProcess”>
    <xs:complexContent>
        <xs:extension base=“bops:tBusinessElement”>
            <xs:sequence>
                <xs:element name=“links” type=“bops:tLinks” minOccurs=“0”/>
                <xs:element name=“businessProcess” type=“bops:tProcess” minOccurs=“0”
maxOccurs=“unbounded”/>
                <xs:element name=“businessTask” type=“bops:tTask” minOccurs=“0”
maxOccurs=“unbounded”/>
                <xs:element name=“artifactRepository” type=“bops:tArtifactRepository”
minOccurs=“0” maxOccurs=“unbounded”/>
                <xs:element name=“roles” type=“bops:tRoles” minOccurs=“0”/>
            </xs:sequence>
            <xs:attribute name=“abstract” type=“xs:boolean” use=“optional” default=“false”/>
            <xs:attribute name=“external” type=“xs:boolean” use=“optional” default=“false”/>
            <xs:attribute name=“automatic” type=“xs:boolean” use=“optional” default=“true”/>
            <xs:attribute name=“transactional” type=“xs:boolean” use=“optional” default=“false”/>
            <xs:attribute name=“compensation” type=“xs:boolean” use=“optional” default=“false”/>
        </xs:extension>
    </xs:complexContent>
</xs:complexType>
```

Business Task

A Business Task is an irreducible functional business element in the business model. Business Tasks work on artifacts. A task has the following attributes:
name: ncname—specifies the name of the task.
automatic: boolean (true|false)—A task with the automatic attribute set to ‘false’ indicates that the task requires human intervention to complete. All tasks inherit the automatic attribute of its parent process and can override it if necessary. If the automatic attribute is not specified, it is assumed to be ‘true’.
transactional: boolean (true|false)—A task with its transaction attribute set to ‘true’ indicates that the task is transactional i.e. if an exception occurs during the processing of the task, the entire task is rolled back. If the transactional attribute is not specified, it is assumed to be ‘false’. All tasks inherit the transactional attribute of its parent process.
compensation: boolean (true|false)—A task with its compensation attribute set to ‘true’ indicates that it supports compensation in the event that an exception occurs. If the compensation attribute is not specified, it is assumed to be ‘false’. All tasks inherit the compensation attribute of its parent process.

A business task consists of ports, taskcontext, roles, and trigger. A business task should have at least one port, while the taskcontext, roles, and trigger are optional. The role is used to identify who has the authority to perform a business task.

The syntactic structure of a business task is:

```
<xs:complexType name=“tTask”>
    <xs:complexContent>
        <xs:extension base=“bops:tBusinessElement”>
            <xs:sequence>
                <xs:element name=“taskContext” type=“bops:tTaskContext” minOccurs=“0”/>
                <xs:element name=“roles” type=“bops:tRoles” minOccurs=“0”/>
                <xs:element name=“trigger” type=“bops:tTrigger” minOccurs=“0”/>
            </xs:sequence>
            <xs:attribute name=“automatic” type=“xs:boolean” use=“optional” default=“true”/>
            <xs:attribute name=“transactional” type=“xs:boolean” use=“optional” default=“true”/>
            <xs:attribute name=“compensation” type=“xs:boolean” use=“optional” default=“false”/>
        </xs:extension>
    </xs:complexContent>
</xs:complexType>
```

Task Context

One or more “contextVariables” may be defined for a task. A task context defines task-specific information. Potential uses of such information is to: Define variables that can be used within Boolean expressions (expressed as predicates) in a port, whose evaluation decides whether a port is active. Assign a value to a scope variable. The resource assignment of a task depends on the correct assignment of the scope variable.

The syntactic structure of a taskcontext is:

```
<xs:complexType name=“tTaskContext”>
    <xs:sequence>
        <xs:element name=“contextVariable” type=“bops:tContextVariableAttribute”
maxOccurs=“unbounded”/>
    </xs:sequence>
</xs:complexType>
<xs:complexType name=“tContextVariableAttribute”>
    <xs:complexContent>
        <xs:extension base=“bops:tAttribute”>
            <xs:sequence>
                <xs:element name=“predicate” type=“bops:tPredicate” minOccurs=“0”/>
            </xs:sequence>
        </xs:extension>
    </xs:complexContent>
</xs:complexType>
```

Trigger

Tasks are functional units that start processing when triggered and are guaranteed to stop after some reasonable time. A task is triggered according to the following: when an artifact enters via an ‘in’ port; when an artifact is available in a repository (in which case the call-back mechanism triggers the task via an ‘out-in’ port); by a timer; or by itself.

The syntactic structure of a trigger is:

```
<xs:complexType name=“tTrigger”>
    <xs:sequence>
        <xs:element name=“port” minOccurs=“0”
        maxOccurs=“unbounded”>
            <xs:complexType>
                <xs:attribute name=“name” type=“xs:NCName”
                use=“required”/>
            </xs:complexType>
        </xs:element>
    </xs:sequence>
    <xs:attribute name=“timer” type=“xs:boolean” use=“optional”
    default=“false”/>
    <xs:attribute name=“self” type=“xs:boolean” use=“optional”
    default=“false”/>
</xs:complexType>
```

Business Artifact Repository

An Artifact repository is the “staging area” for business artifacts. An instance of an Artifact Repository can only hold artifacts of a particular type. Artifact repository is used to model temporal dependency with ordering constraints in the business model. An artifact repository has the following attribute: name: ncname—that specifies the name of the artifact repository. Ports define the interface of an artifact repository. Since an artifact repository can hold only one type of artifact, all the ports must reference the same artifact type. The valid port directions are: ‘in’, ‘out’, and ‘in-out’.

The syntactic structure of an artifact repository is:

```
<xs:complexType name=“tArtifactRepository”>
    <xs:complexContent>
        <xs:extension base=“bops:tBusinessElement”/>
    </xs:complexContent>
</xs:complexType>
```

Resource Model

The Resource Model describes the actors performing business tasks, as well as their capabilities. A set of capabilities to perform business tasks defines a role. Actors are modeled as resources, and resources qualify for a role, if they are capable of executing the corresponding tasks. They may then be assigned to these task for execution, if they are available, and not restrained by scope considerations (see below). Note that “performing” and “assisting” resources at this level of the model is not differentiated. The boundary between the two is blurred, and usually resources participating in task execution will be occupied, consumed, or charged for, regardless of whether they are “performing” or “assisting”. Even if a resource is capable of performing a business function (i.e., it qualifies for the corresponding role), there may be limitations on its capability to perform a task that depend on the task instance. For example, several people in a company may have an “approver” role for purchase orders, but depending on the type and value of products ordered, not every one may qualify to approve every order. The concept of scope is introduced to model such instance-dependent restrictions of resource capabilities.

Resources

Resources can be human or automated (machine or system resource). In addition, an external resource type is introduced to model resources that may be beyond control of, unknown to, or irrelevant for, the process owner (opaque resource). It is understood that while the three types of resources (human, system, external) appear identical at this level of the model, differences become apparent in extensions and refinements, such as for process simulation or IT implementation. For example, human resources may eventually be mapped to entries in a corporate directory. System resources will be implemented by applications, machines, or automated tools, and may require connectors or adapters to participate in automated process execution. External resources will be different from the other two types in throughput simulations (the quantity and availability of the resource may be unknown, or unlimited), cost calculations (their cost is incurred by a third party), and IT implementations (their interactions require a B2B gateway). Resources are characterized by cost and availability, and should be thought of as “tangible” process actors having a distinguished identity (for example: Accountant Bill Smith, SAP System 4224, Airline reservation service www.flyright.com). Resources are not to be confounded with roles, which designate mere capabilities (for example: manufacturing specialist, travel agent, lead buyer, expense account approver). The same role can be taken on by resources with very different cost characteristics: for example, depending on who approves an expense account, the cost per hour in performing this task may vary greatly. As will be discussed in greater detail hereinbelow.

As an example, a human resource may be an employee in the accounting department, or a team of four IT specialists. An example for a system resource is an SAP R/3 system. An example for an external resource is an airline reservation service.

```
<?xml version=“1.0” encoding=“UTF-8”?>
<resourceModel >
    <resources>
        <humanResource name=“Accounting Clerk 01”/>
        <humanResource name=“Accounting Clerk 02”/>
        <systemResource name=“SAP System 4224-A”/>
        <externalResource name=“www.flyright.com”/>
    </resources>
</resourceModel>
```

Resources may be aggregated. Aggregations of human resources, system resources, or external resources define a new (compound) resource of the same type. Aggregations of resources having different types creates a new “un-typed” resource. Combining un-typed resources with any resource will again create an un-typed resource. For example: Aggregations of human resources may be thought of as “teams” or “work groups”. Defining aggregations of system resources, as well as “mixed bags” of human and system resources, may be useful when these are usually deployed in combination. For example, an accounting process may require a resource consisting of a member of the accounting department and the corporate accounting system; a rescue operation may require a helicopter, a pilot, and a physician.

Furthermore, resource aggregations may be nested, and three basic aggregation types are allowed: a bag (unordered set); a sequence (ordered set); and a choice (alternatives). If no aggregation type is specified, a bag is the default. When assigning compound resources, the assignment of a bag will bind all resources it contains to the task. The assignment of a choice indicates that one of the resources in this set will be assigned; its selection is subject to availability, scope, or other runtime constraints, but no ranking or preference for picking a particular resource is indicated in the resource model. The semantics of assigning a sequence are similar to assigning a choice (one resource will be picked), but the sequence pre-defines some preference or priority in making this selection. An example for a resource bag is a work group; an example for a sequence is a list of shipment services ranked by cost or speed; an example for a choice is a set of corporate chauffeurs.

```
<resourceModel>
    <resources>
        <humanResource name=“The Hauling Squad”
        aggregationType=“bag”>
            <!-- same as previous example, but aggregation type
            made explicit -->
            <humanResource name=“A1”/>
            <humanResource name=“Bob”/>
            <humanResource name=“Chuck”/>
            <humanResource name=“Dan”/>
        </humanResource>
        <resource name=“Shipping Service”
        aggregationType=“sequence”>
            <resource name=“The Overnight Express”/>
            <resource name=“The Courier Service”/>
            <resource name=“The Postal Service”/>
        </resource>
        <humanResource name=“Limousine Driver”
        aggregationType=“choice”>
            <humanResource name=“A. Abrams”/>
            <humanResource name=“B. Baker”/>
            <humanResource name=“C. Chung”/>
        </humanResource>
    </resources>
</resourceModel>
```

Finally, resources may be owned by organizations, which may be internal (e.g., departments, divisions) or external to the enterprise (e.g., business partners, external service providers). Modeling these organizations, their hierarchical structures, and their ownership of resources, however, is outside the realm of the core model. Such capabilities may be added in a model extension, for example, for process simulation.

Role

The functional capabilities of resources are described by assigning them roles, which are defined as aggregations of capabilities to perform business tasks. In IT implementations of business processes, roles are frequently used to denote authorizations or permissions to perform business functions. In an enterprise security model based on BOpS, the role concept introduced herein may be extended in this way. The assignment of a role to a resource may be scoped, in which case the resource's capability to perform the role is not universally granted for all task instances, but depends on the task at hand. As an example, a car manufacturer defines a corporate lead buyer role for procurement agents. A lead buyer's job is to ensure that purchasing contracts for production material are in line with the corporate procurement strategy. In a corporate procurement process this role may aggregate the capabilities to “approve blanket orders”, “change supplier ratings”, and “set supplier volume limits”. However, whether an employee having the lead buyer role may actually perform these tasks depends on the class of material purchased (its so-called commodity type) as well as the geographic location of the supplier. Thus, the lead buyer role is “scoped” by supplier location and commodity type. Examples for such scoped lead buyer roles would be: “lead buyer for tires purchased from U.S. based suppliers”, “lead buyer for any class of material purchased from German suppliers”, or “worldwide lead buyer for shock absorbers”.

```
<resourceModel>
    <!-- Declaring the lead buyer role -->
    <roles>
        <role name=“lead buyer”/>
    </roles>
    <!-- Declaring a Lead Buyer, and down-scoping her lead
    buyer role -->
    <resources>
        <resource name=“Patricia Goldman”>
            <roles>
                <role name=“lead buyer”>
                    <scope name=“commodity type” value=“tires”/>
                    <scope name=“supplier location”
                    value=“United States”/>
                </role>
            </roles>
        </resource>
    </resources>
</resourceModel>
```

Scopes are modeled in BOpS as name-value pairs assigned to a resource's roles. They “down-scope” the role for the resource. The scope name defines a domain for the scope (examples are: commodity type, supplier location, sales region, customer status) and the scope value the restriction of the scope within that domain (for example: commodity type=64, supplier location=Germany, sales region=EMEA, customer status=Gold, . . . ). Down-scoping the roles assigned to resources—referred to as resource qualifications—implicitly requires that a “scoping algorithm” be defined for each task requiring such a scope restricted role: it must map each instance of the task into the various scope domains defined for the roles it requires.

In the above example, the car manufacturer's procurement process includes a contract approval task to be performed by a lead buyer. This task has an associated scoping algorithm, which determines the applicable commodity type and supplier location for each contract. This will involve parsing the contract and looking up the commodity type for each line item of production material ordered. It may also involve looking up a supplier's geographic location in a supplier database.

If several scopes are assigned from the same domain, then the resulting scope is their union. After forming the union of scopes by domain, the total scope is defined as the Cartesian product across domains. Thus, for example, a sales agent whose scope is defined as (sales region=Germany, sales region=Austria, sales region=Switzerland) is responsible for the three German-speaking countries (union of the three scopes). A lead buyer whose scope is defined as (commodity type=light bulbs, commodity type=wiper blades, supplier location=Texas, supplier location=Arizona, supplier location=New Mexico) is responsible for purchases of light bulbs and wiper blades from suppliers located in these three states (Cartesian product of unions).

```
<resourceModel>
    <roles>
        <role name=“sales agent”/>
        <role name=“lead buyer”/>
    </roles>
    <resources>
        <resource name=“Sales Agent Germany and Alpine Countries”>
            <roles>
                <role name=“sales agent”>
                    <scope name=“sales region” value=“Germany”/>
                    <scope name=“sales region” value=“Austria”/>
                    <scope name=“sales region”
                    value=“Switzerland”/>
                </role>
            </roles>
        </resource>
        <resource name=“Lead Buyer 007”>
            <roles>
                <role name=“lead buyer”>
                    <scope name=“commodity type”
                    value=“light bulbs”/>
                    <scope name=“commodity type”
                    value=“wiper blades”/>
                    <scope name=“supplier location”
                    value=“Texas”/>
                    <scope name=“supplier location”
                    value=“Arizona”/>
                    <scope name=“supplier location”
                    value=“New Mexico”/>
                </role>
            </roles>
        </resource>
    </resources>
</resourceModel>
```

Frequently, scopes have a hierarchical structure. Examples include geographic locations (states within countries within geographic regions), corporate units (departments within divisions within corporate groups), or categories of products. Defining a scope as a node in such a structure is equivalent to defining it as the set of all subordinate leaves. Thus, for example, an electronics manufacturer defines a sales director role whereby a sales director is responsible for a geographic area. The company's sales areas are hierarchically structured, with geographic (NorthAmerica, LatinAmerica, EMEA, AsiaPacific) at the top level, individual countries at the next level, and states or provinces within countries at the lowest level.

In order to document the hierarchical structure of a scope domain, or to enumerate all possible scope values, one may declare the set of permitted scope values as part of the role definition. If such a “scopes”declaration is present, it is understood that the scope restrictions for resource qualifications must be a subset of the scopes thus declared. As an example, an airline company defines a customer service representative role which is scoped by customer status. The role definition for customer service representative lists Silver, Gold, and Platinum as the three possible scope values for customer status. Declaring a customer service representative with customer status=None or customer status=All would thus be an error. If no scope values had been declared under the customer service representative role, then any value for customer status would have been permissible. Also shown in the following XML example is the sales director role introduced above, scoped by geographic area. The role declaration includes the hierarchical structure of the company's sales regions.

Constraint Model

The constraint model describes the constraints that must be satisfied for a BOpS model to be semantically valid. It reflects the operational semantics of the model. Constraints may be of 2 types: 1) Metadata Constraints—which are semantic constraints that need to be specified over and above the schema constraints. These are schema level constraints (but were unable to be specified by the schema) and will usually pertain to all Instance documents; and 2) Model Constraints—which are semantic constraints specific to an Instance document. These constraints reflect the business rules/logic that need to be evaluated in order to validate the model.

While the invention has been particularly shown and described with respect to illustrative and preformed embodiments thereof, it will be understood by those skilled in the art that the foregoing and other changes in form and details may be made therein without departing from the spirit and scope of the invention which should be limited only by the scope of the appended claims.

1. A system for creating and managing a business process integration solution comprising:
means for modeling a business strategy including elements representing business measurements and initiatives according to defined business goals and objectives of an entity;
means for modeling business operations of said entity in terms of business process elements including process tasks, artifact flows and artifact repositories, said business process element incorporating key performance indicators; and
data structures means for mapping elements of the strategy model with artifact and process elements of the operations model, means for measuring business performance and comparing performance against said key performance indicators, wherein said business strategy and operation model process elements may be continuously refined over a solution development lifecycle as a result of process measurements and comparing.

2. The system as claimed in claim 1, further comprising means for transforming operations model elements into a platform independent information technology (IT) executable solution model comprising business solution artifacts.

3. The system as claimed in claim 2, wherein solution artifacts includes business objects representing business documents or materials, contracts or work products.

4. The system as claimed in claim 2, wherein solution artifacts includes adaptive business objects capturing state-dependent behavior.

5. The system as claimed in claim 2, wherein solution artifacts includes macroflows representing interruptible process flows and microflows representing represent non-interruptible process flows.

6. The system as claimed in claim 2, wherein solution artifacts includes application adapters that transform data for and interface with application software.

7. The system as claimed in claim 2, wherein solution artifacts includes business-business connectors that transform data for and interface with external business systems.

8. The system as claimed in claim 2, wherein solution artifacts includes portal artifacts that enable human users to interact with the solution.

9. The system as claimed in claim 2, further comprising means for defining details of one or more said IT solution artifacts in a manner such that said solution artifacts may be bound and deployed to one or more specific runtime platforms.

10. The system as claimed in claim 2, wherein said transforming means transforms said key performance indicators into IT probes in the IT executable solution model, said probes for real-time monitoring and reporting business process performance as measured by said key performance indicators defined in the operation model.

11. The system as claimed in claim 1, further comprising means for recommending or effecting changes to a business process to improve its performance in view of said business measuring means.

12. The system as claimed in claim 1, wherein said means for measuring and comparing business performance includes a simulation means implementing simulation models in at least one of the strategy, operation, execution and implementation models.

13. The system as claimed in claim 1, wherein said means for modeling business operations of said entity include implementing a business level modeling language for formally representing said business operations.

14. The system as claimed in claim 1, wherein said business level modeling language for formally representing said business operations models business operations according to a schema.

15. The system as claimed in claim 14, wherein said schema represents an information model including artifacts and business events pertaining to an operational view of said business entity.

16. The system as claimed in claim 1, wherein said schema represents an business functions including processes, tasks, artifact repositories and their interconnections

17. The system as claimed in claim 1, wherein said schema represents an resources including roles and resource groups.

18. A method for creating and managing a business process integration solution comprising the steps of:
a) modeling a business strategy including elements representing business measurements and initiatives according to defined business goals and objectives of an entity;
b) modeling business operations of said entity in terms of business process elements including process tasks, artifact flows and artifact repositories, and business commitment elements including incorporating key performance indicators;
c) mapping elements of the strategy model with artifact and process elements of the operations model; and,
d) measuring business performance and comparing performance measurements against said key performance indicators, wherein said business strategy and operation model process elements may be continuously refined over a solution development lifecycle as a result of process measurements and comparing.

19. The method as claimed in claim 18, further comprising the step of transforming operations model elements into a platform independent information technology (IT) solution model comprising business solution artifacts.

20. The method as claimed in claim 19, wherein solution artifacts include one or more selected from the group comprising: business objects adaptive business objects, macroflows, microflows application adapters, business-business connectors, and portal artifacts.

21. The method as claimed in claim 19, further comprising the step of defining details of one or more said IT solution artifacts, binding and deploying said solution artifacts to one or more specific runtime platforms.

22. The method as claimed in claim 21, further comprising the step of: transforming said key performance indicators into IT probes in the IT executable solution model, said probes enabling real-time monitoring and reporting of business process performance as measured by said key performance indicators defined.

23. The method as claimed in claim 22, further comprising the step of recommending or effecting changes to a business process to improve its performance in view of said monitoring.

24. The method as claimed in claim 19, further including implementing a business level modeling language for formally representing said business operations, said representing of said business operations models business operations according to a schema.

25. A computer storage device tangibly embodying a plurality of instructions for carrying out a method for creating and managing a business process integration solution, the method steps comprising:
a) modeling a business strategy including elements representing business measurements and initiatives according to defined business goals and objectives of an entity;
b) modeling business operations of said entity in terms of business process elements including process tasks, artifact flows and artifact repositories, and business commitment elements including incorporating key performance indicators;
c) mapping elements of the strategy model with artifact and process elements of the operations model; and,
d) measuring business performance and comparing performance measurements against said key performance indicators, wherein said business strategy and operation model process elements may be continuously refined over a solution development lifecycle as a result of process measurements and comparing.
